(19) United States
(12) Patent Application Publication
(10) Pub. No.: US 2009/0066318 A1
(43) Pub. Date: Mar. 12, 2009

(54) SENSOR DEVICE WITH ALTERNATING EXCITATION FIELDS

(75) Inventors: Josephus Arnoldus Henricus Maria Kahlman, Tilburg (NL); Albert Hendrik Jan Immink, Eindhoven (NL); Haris Duric, Helmond (NL); Adrianus Johannes Maria Van Tuijl, Eindhoven (NL); Eugenio Cantatore, Eindhoven (NL); Hendrik Johannes Bergveld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/282,889

(22) PCT Filed: Mar. 6, 2007
(86) PCT No.: PCT/IB07/50733

§ 371 Date: Sep. 15, 2008

(30) Foreign Application Priority Data
Mar. 16, 2006 (EP) 06111187.8

(51) Int. Cl. G01N 27/74

(52) U.S. Cl. 324/204

(57) ABSTRACT

The invention relates to a magnetic sensor device comprising excitation wires (11, 13) for generating a magnetic excitation field and a magnetic sensor element, particularly a GMR sensor (12), for sensing magnetic fields generated by labeling particles in reaction to the excitation field. The magnetic excitation fields are generated with non-sinusoidal forms, particularly as square-waves, such that their spectral range comprises a plurality of frequency components. Magnetic particles with different magnetic response characteristics can then be differentiated according to their reactions to the different frequency components of the excitation fields. The magnetic excitation field and the sensing current driving the GMR sensor (12) are preferably generated with the help of ring modulators (22, 24). Moreover, ring modulators (27, 29) may be used for the demodulation of the sensor signal.

The invention relates to a magnetic sensor device comprising at least one magnetic field generator and at least one associated magnetic sensor element together with associated power supply units. Moreover, the invention relates to the use of such a magnetic sensor device and a method for the detection of magnetized particles of different magnetic properties.

From the WO 2005/010543 Al and WO 2005/010542 A2 a microsensor device is known which may for example be used in a microfluidic biosensor for the detection of molecules, e.g. biological molecules, labeled with magnetic beads. The microsensor device is provided with an array of sensors comprising wires for the generation of an alternating sinusoidal magnetic field and Giant Magneto Resistances (GMR) for the detection of stray fields generated by magnetized, immobilized beads. The signal of the GMRs is then indicative of the number of the beads near the sensor.

A problem of measurements with magnetic sensor devices of the aforementioned kind is that the magnetic properties of magnetic beads may be dispersed so that the number of magnetized beads does not have an unambiguous relation with the magnetic response. As a result the accuracy of the sensor may degrade.

Based on this situation it was an object of the present invention to provide means for an accurate detection of magnetic particles of different magnetic properties.

This objective is achieved by a magnetic sensor device according to claim 1, a method according to claim 22, and a use according to claim 27. Preferred embodiments are disclosed in the dependent claims.

A magnetic sensor device according to the present invention serves for the detection of magnetized particles and comprises the following components:
At least one magnetic field generator for generating a magnetic excitation field in an adjacent investigation region. The magnetic field generator may for example be realized by one or more wires on a substrate of a microsensor.
At least one magnetic sensor element for recording the magnetic reaction fields generated by the magnetized particles in reaction to the excitation field. The magnetic sensor element may particularly be a magneto-resistive element of the kind described in the WO 2005/010543 A1 or WO 2005/010542 A2, especially a GMR, a TMR (Tunnel Magneto Resistance), or an AMR (Anisotropic Magneto Resistance). Further kinds of magnetic sensor elements are applicable.
An “excitation power supply unit” for providing the magnetic field generator with an excitation current that comprises at least two spectral components in its frequency spectrum.

The described magnetic sensor device allows to generate magnetic excitation fields that have at least two spectral components and are thus able to measure a sample simultaneously at two or more different points of its spectral characteristic. The measured sensor signals therefore comprise more information than measurements with simple DC or sinusoidal excitation fields.

According to a further development of the invention, the magnetic sensor device comprises an evaluation unit (e.g. an analog or digital on-chip circuit or an external digital processing unit) for extracting the individual contributions of particles of different properties from the recorded magnetic reaction fields. In practice it turns out that magnetic particles which are for example used as labels for target molecules are not identical in their magnetic properties due to for example unavoidable production tolerances. The evaluation unit then allows the allocation of observed magnetic reaction fields to different classes of particles and thus a more accurate determination of the whole number of present particles. The separation of individual contributions of particles in the overall magnetic response can further be exploited when distinct magnetic particles are used arbitrarily, for example to label distinct types of target molecules differently.

The excitation power supply unit may be realized in different ways. According to one embodiment, it comprises at least two oscillators, particularly sine oscillators for generating two spectral components directly. The term “oscillator” shall refer here in a very general sense to a component that generates an alternating, preferably periodic signal (e.g. a voltage) at its output.

In another realization, the excitation power supply unit is adapted to generate a square-wave excitation current of an excitation frequency f₁, wherein said frequency describes the periodicity of the square waves. Advantageous of a square-wave is that it comprises spectral components at multiples of the basic excitation frequency and therefore quasi covers the whole spectral range. Furthermore, applying square-wave excitation fields does have interesting signal processing consequences, which makes IC integration easier.

The excitation power supply unit may especially comprise an “excitation” ring modulator, an “excitation” current source (optionally but not necessarily being a constant current source), and an “excitation” oscillator, wherein the words “excitation” shall indicate that the corresponding components belong to the excitation power supply unit. The excitation power supply unit provides the magnetic field generator with an alternating excitation current of an excitation frequency f₁, wherein said current leaves the output of the excitation ring modulator (abbreviated “RM” in the following), and wherein the RM is controlled by the excitation oscillator and wherein the RM is coupled with its input to the excitation current source. The ring modulator RM (or “chopper”) is a circuitry that is well known from the field of signal conversion (ADC and DAC) and telecommunication and that is described in standard textbooks of electronics (e.g. Tietze, Schenk: “Halbleiter-Schaltungstechnik”, Springer Verlag, 11th ed., Ch. 1.4.5). A ring modulator has an input where it receives a signal of an input frequency, a control input where it receives a control signal of a control frequency, and an output where it provides an output current or voltage, wherein the output signal is a mixture, particularly the product, of the input signal and the control signal. By using a ring modulator for the generation of an excitation current, the described magnetic sensor device is able to generate magnetic excitation fields of different properties, particularly excitation fields that vary periodically with an excitation frequency in a non-sinusoidal way.

According to a further development of the aforementioned embodiment, the excitation current source provides a direct current, and the excitation oscillator provides a square-wave of the excitation frequency f₁ as control signal. As a result, the excitation current at the output of the excitation RM will be a square-wave of the excitation frequency, too.

The described designs of the excitation power supply unit may be realized mutatis mutandis at the sensor side, too. Thus the magnetic sensor device may optionally comprise a “sensor power supply unit” for providing the magnetic sensor element with a square-wave sensing current of a sensing frequency f₂.

Moreover, a sensor power supply unit may comprise a “sensing” ring modulator, a “sensing” current source (optionally but not necessarily being a constant current source), and a “sensing” oscillator, wherein the words “sensing” shall indicate that the corresponding components belong to the sensor power supply unit. The sensor power supply unit provides the magnetic sensor element with an alternating sensing current of a sensing frequency f₂, wherein said current leaves the output of the sensing RM, and wherein the RM is controlled by the sensing oscillator, and wherein the RM is coupled with its input to the sensing current source.

The sensing current source may optionally provide a direct current, and the sensing oscillator may provide a square-wave of the sensing frequency as control signal. As a result, the sensing current at the output of the sensing RM will be a square-wave, too.

The excitation frequency f₁ and the sensing frequency f₂ of the various embodiments described above preferably fulfill the following relation: p·f₂≠q·f₁±r·f₂, wherein p, q, and r are arbitrary odd integers. Such a choice has the advantage that harmonic content from the sensing frequency in the magnetic signal is avoided.

The excitation frequency f, may optionally be larger than the sensing frequency f₂, wherein the ratio f₁:f₂ may particularly range between 10 and 1000.

In another embodiment, the excitation frequency f₁ and the sensing frequency f₂ are chosen to be close together, wherein the ratio f₁:f₂ may particularly range between 0.8 and 1.2.

The excitation oscillator and the sensing oscillator are preferably driven by a common reference oscillator to minimize phase drift between excitation and the sensing frequency.

According to a further development of the invention, the magnetic sensor device comprises at least one demodulator that is (directly or indirectly) coupled to the magnetic sensor element and that is driven by the excitation frequency f₁, the sensing frequency f₂, or the result of an exclusive-or operation between the excitation frequency f₁ and the sensing frequency f₂. The use of an exclusive-or operation is particularly advantageous in connection with an IC design.

In a particular realization of the aforementioned embodiment, the magnetic sensor device comprises a first “demodulation” RM (ring modulator) that is controlled by a first control signal, said signal being derived from the excitation oscillator, and that is coupled at its input to the output of the magnetic sensor element. The first demodulation RM allows to demodulate the sensor signal directly without amplification to avoid dynamic range problems.

In the aforementioned embodiment, the first control signal is preferably determined by the output of the excitation oscillator (i.e. the first control signal is identical to the control signal of the excitation RM). Alternatively, the first control signal may be determined by an exclusive-or (XOR) operation between the outputs of the excitation oscillator and another oscillator, particularly the sensing oscillator. Different processing circuits that make use of the two described alternatives will be described in more detail with reference to the Figures. The general effect of the first demodulator RM is to separate components in the sensor signal that relate to the magnetic excitation field.

The magnetic sensor device with the first demodulation RM preferably comprises a high-pass filter or a low-pass filter at the input side and/or at the output side of said RM. By such filters, undesired signal components can be removed from the sensor signal. The application of the high-pass filter “at the input side” shall mean that such a filter is inserted anywhere between the magnetic sensor element and the first demodulation RM, i.e. there may be other components in between. Similarly, the low-pass filter at the output side may be directly or indirectly coupled to the output terminals of the first demodulation RM.

The magnetic sensor device with the first demodulation RM may further comprise an amplifier at the input side and/or at the output side of said RM. This amplifier is preferably a low noise amplifier to deteriorate the signal quality as little as possible.

According to a further development of the invention, the magnetic sensor device comprises a second demodulation RM that is controlled by a second control signal, said control signal being derived from the sensing oscillator, and that is (directly or indirectly) coupled at its input to the output of the first demodulation RM. The application of a second demodulation RM allows to extract the desired measurement signal as a DC component from the preprocessed sensor signal.

In the aforementioned embodiment, there may optionally be a high-pass filter at the input side and/or a low-pass filter at the output side of the second demodulation RM in order to suppress undesired signal components.

According to another embodiment of the invention, the magnetic sensor device comprises a third RM between the magnetic sensor element and the first demodulation RM, wherein said third RM is controlled by the sensing oscillator. The third RM allows to remove the large base band components at the sensing frequency in the sensor signal prior to a further processing of this signal.

The invention further relates to a method for the detection of magnetized particles, the method comprising the following steps:
The generation of a magnetic excitation field having at least two spectral components. The excitation field may particularly have a square-wave character with an excitation frequency f, (wherein f, describes the periodicity of the square-wave, which results in a series of spectral components in the frequency spectrum).
Recording the time-varying magnetic reaction fields generated by the particles in reaction to the excitation field.

In a further development, the method comprises the extraction of individual contributions of particles of different properties from the recorded reaction fields.

The above method allows, by the application of a magnetic excitation field with more than one Fourier-frequency component, the allocation of observed magnetic reaction fields to different classes of particles and thus a more accurate determination of the whole number of present particles. The separation of individual contributions of particles in the overall magnetic response can further be exploited when distinct magnetic particles are used arbitrarily, for example to label distinct types of target molecules differently.

The extraction of the individual contributions of particles may be done in different ways. According to a first alternative, the individual contributions are extracted from the spectrum of the reaction fields based on the known spectral behaviors of the particles. In another approach, time-varying model functions that describe the responses of particular particles are fitted to the recorded reaction fields, wherein different fitting methods known in the state of the art may be applied. The model functions may particularly be exponential functions with the decay time as (one) fitting parameter.

The invention further relates to the use of the magnetic sensor device described above for molecular diagnostics, biological sample analysis, or chemical sample analysis. Molecular diagnostics may for example be accomplished with the help of magnetic beads that are directly or indirectly attached to target molecules.

These and other aspects of the invention will be apparent from and elucidated with reference to the embodiment(s) described hereinafter. These embodiments will be described by way of example with the help of the accompanying drawings in which:

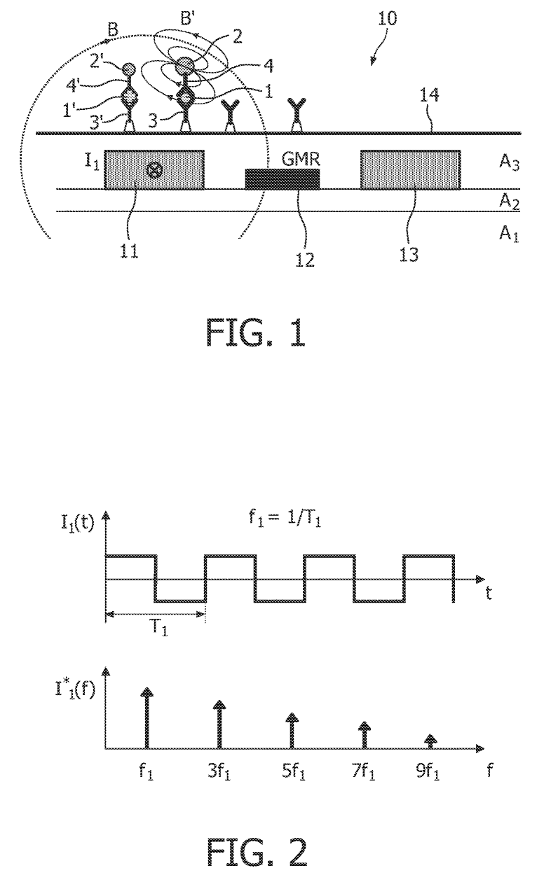

FIG. 1 schematically shows a magnetic sensor device according to the present invention;

FIG. 2 shows a square-wave of excitation current and its frequency spectrum;

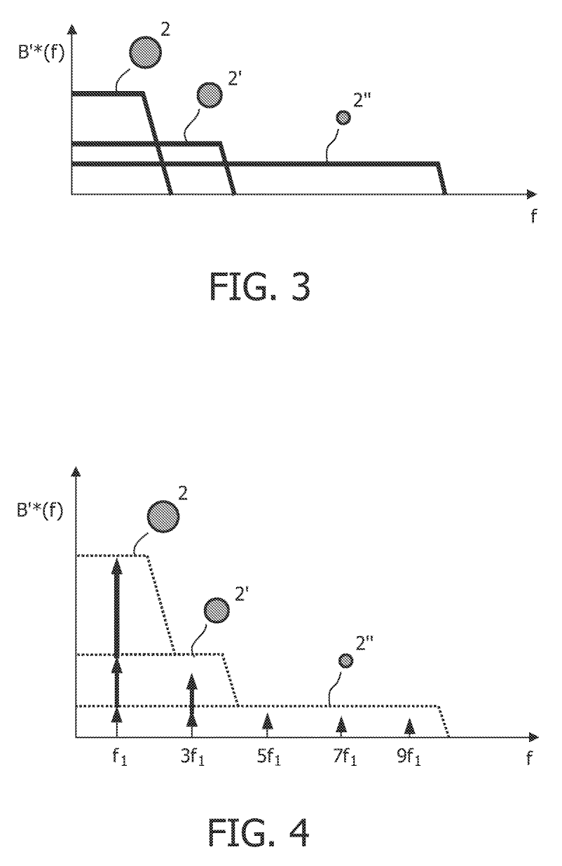

FIG. 3 illustrates the frequency responses of three magnetic particles of different size;

FIG. 4 shows the resulting total readout signal obtained from a GMR sensor when magnetic beads of different size are present;

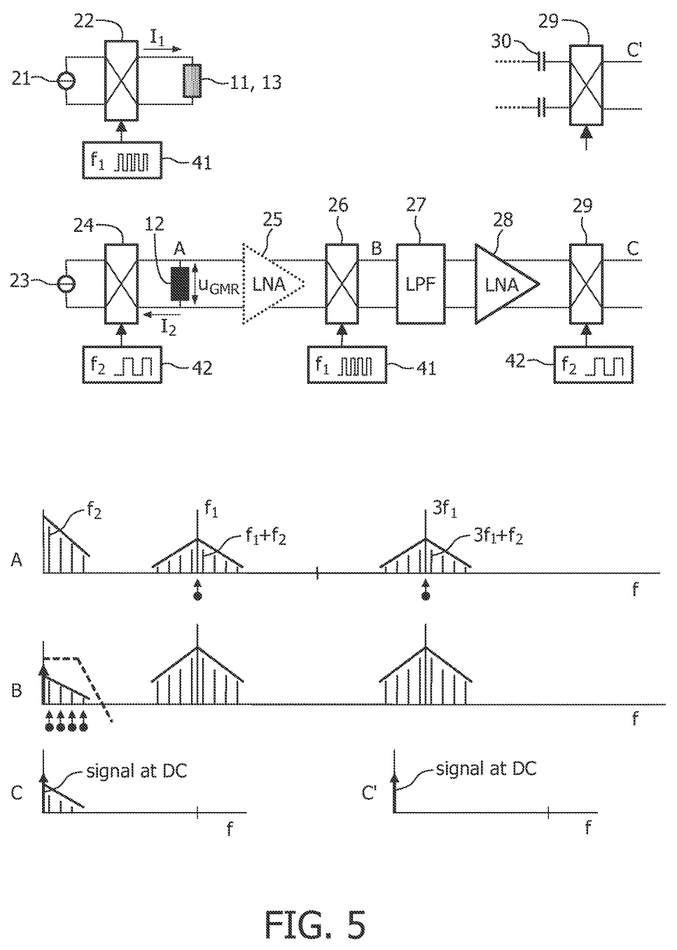

FIG. 5 shows a first design of a processing circuit for a magnetic sensor device according to the present invention and the frequency spectrum of the processed signal at different stages;

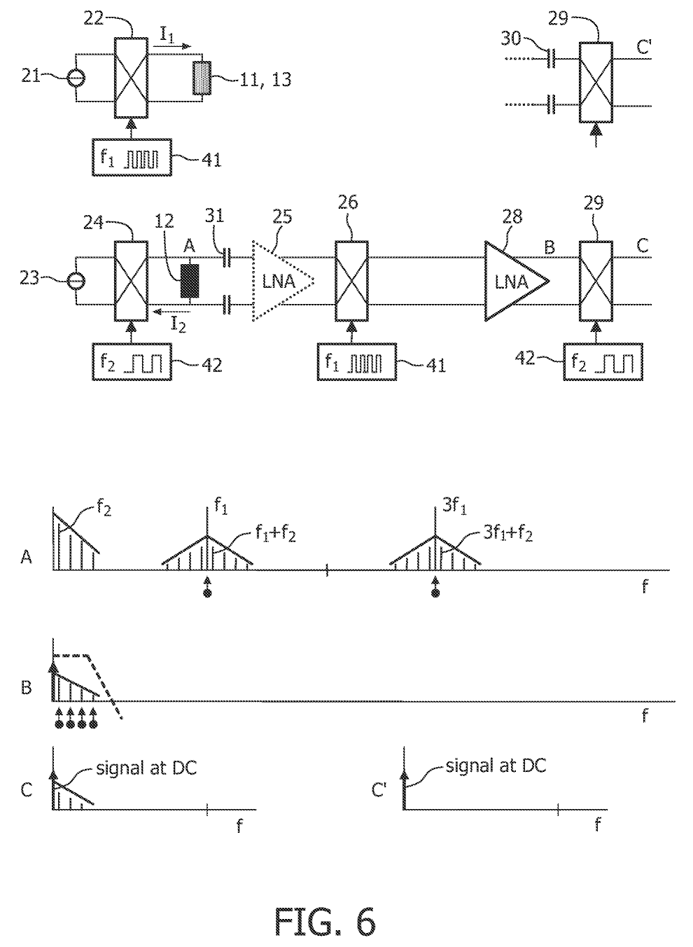

FIG. 6 shows a modification of the design of FIG. 5, wherein a high-pass filter is inserted before the processing components;

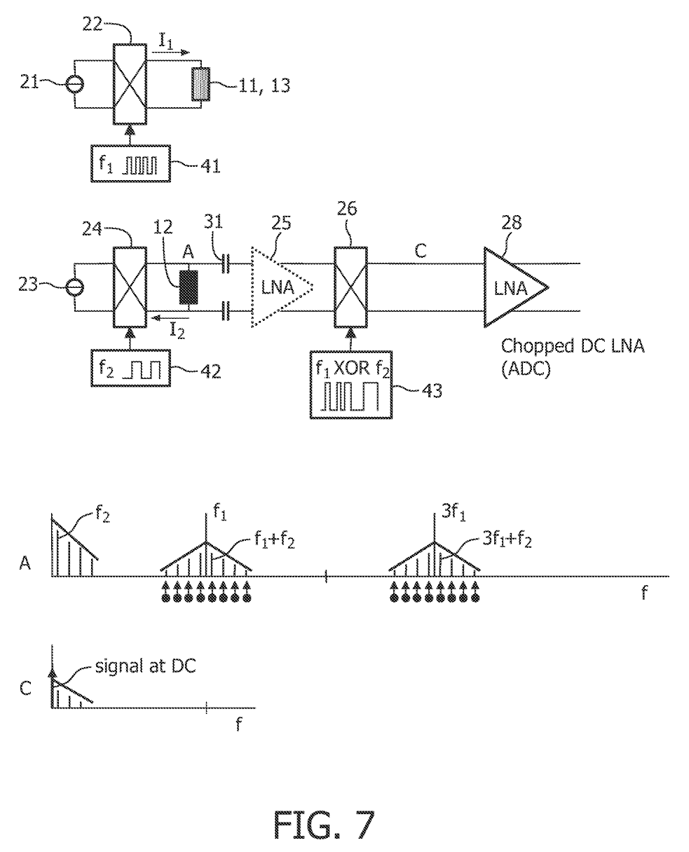

FIG. 7 shows a modification of the design of FIG. 6, wherein demodulation frequencies are generated by an exclusive-or function;

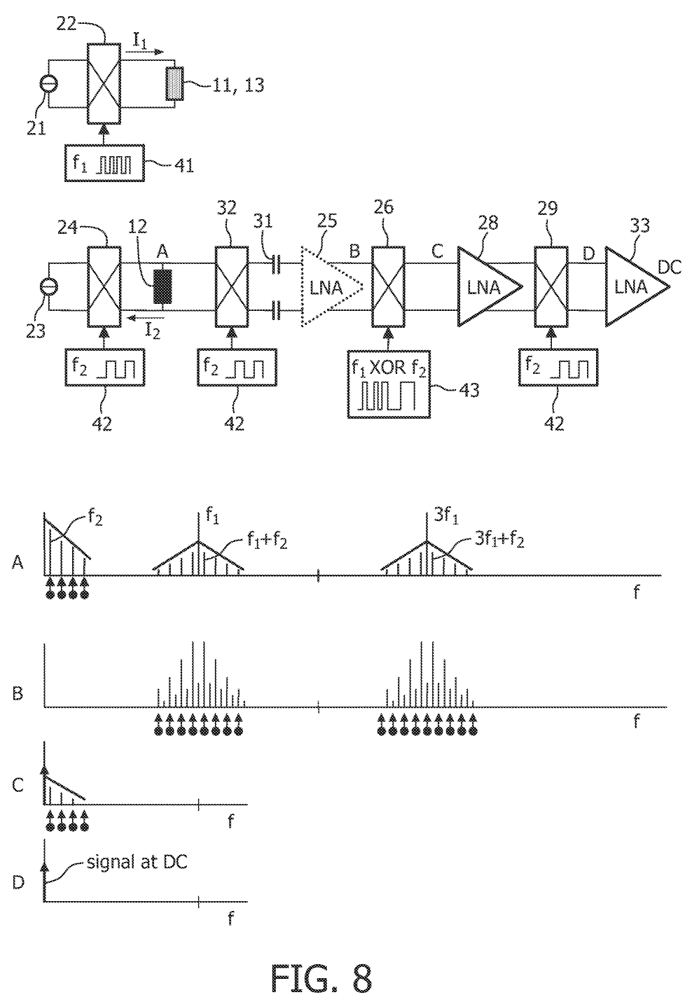

FIG. 8 shows a modification of the design of FIG. 6, wherein a third RM is used to filter the original sensor signal;

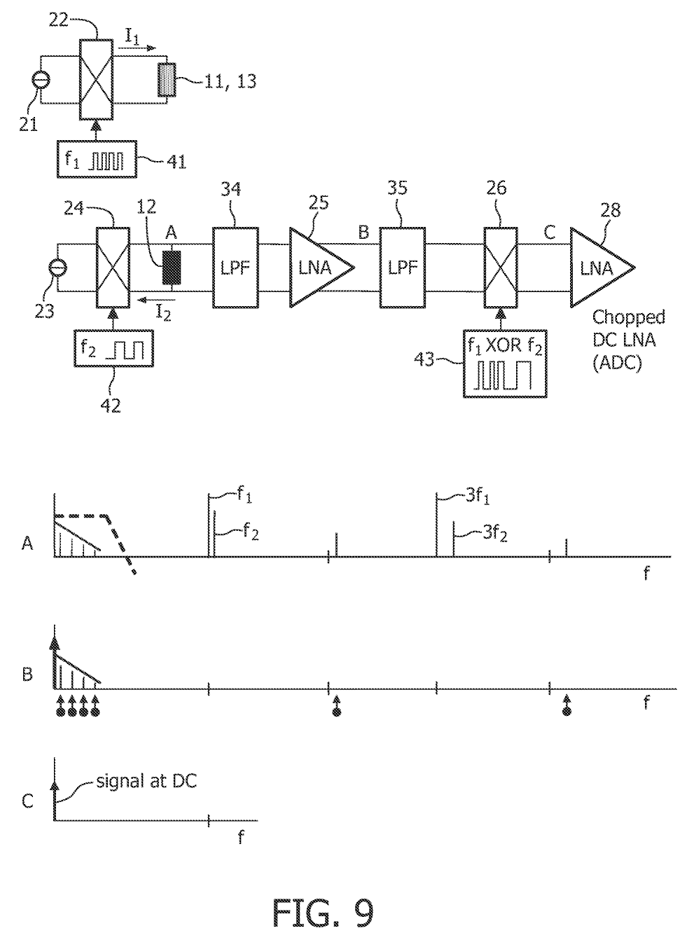

FIG. 9 shows a modification of the design of FIG. 7, wherein the excitation and sensing frequencies are close together.

Like reference numbers in the Figures refer to identical or similar components.

FIG. 1 illustrates a microelectronic magnetic sensor device 10 according to the present invention in the particular application as a biosensor for the detection of magnetically interactive particles, e.g. superparamagnetic beads 2, 2′ in a sample chamber. Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

A biosensor typically consists of an array of (e.g. 100) sensor devices 10 of the kind shown in FIG. 1 and may thus simultaneously measure the concentration of a large number of different target molecules 1, 1′ (e.g. protein, DNA, amino acids, drugs of abuse) in a solution (e.g. blood or saliva). In one possible example of a binding scheme, the so-called “sandwich assay”, this is achieved by providing a binding surface 14 with first antibodies 3, 3′ to which the target molecules 1, 1′ may bind. Superparamagnetic beads 2, 2′ carrying second antibodies 4, 4′ may then attach to the bound target molecules 1, 1′. A current flowing in the excitation wires 11 and 13 of the sensor 10 generates a magnetic field B, which then magnetizes the superparamagnetic beads 2, 2′. The stray field B′ from the superparamagnetic beads 2, 2′ introduces an in-plane magnetization component in the GMR 12 of the sensor device 10, which results in a measurable resistance change.

The magnetic sensor device 10 can be any suitable sensor device 10 based on the detection of the magnetic properties of particles to be measured on or near to the sensor device surface. Therefore, the magnetic sensor device 10 is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, GMR (Giant Magneto Resistance), or as another sensor actuated by a magnetic field. In the examples given the magnetic sensor device 10 comprises a GMR (Giant Magneto Resistance).

As shown in FIG. 1, beads 2, 2′ of different properties (e.g. of different size) may be bound via molecules 4, 4′ to different target molecules 1, 1′ that are linked to the same or different receptors 3, 3′ on the surface 14 of the sensor device.

FIG. 1 further indicates a possible layered composition of the magnetic sensor device 10, wherein a first, lower layer A₁ comprises signal processing means (not shown). Separated by an intermediate passivation layer A₂, the aforementioned sensor components 11, 12, 13 are located in an upper layer A₃. Such a placement of the sensor elements on top of signal processing means is applied in order to achieve a high grade of integration at a reduced effect of unwanted bandwidth limiting parasitic components. As already mentioned, the biosensor chip may comprise a plurality of sensor devices connected to signal processing units to realize multi biological measurements on the same chip. In order to reduce the amount of chip area, these sensor devices may share common signal-processing parts via multiplexing. Moreover, signal processing-units may be operating in time-sequential mode in order to reduce power consumption.

One of the problems associated with a magnetic sensor device of the described kind is that the magnetic properties of magnetic beads may be dispersed so that the number of immobilized beads does not have an unambiguous relation with the magnetic response. As a result the accuracy of the sensor may degrade. Furthermore, it may be advantageous to detect a plurality of different target molecules on a single GMR sensor by using magnetic beads having different biological interfaces and different magnetic properties. An intelligent detection mechanism is therefore required to distinguish between the responses from different beads on the same sensor. Finally, it is desirable to use in IC design square-wave signals for excitation, sensing and demodulation as they are easy to generate and avoid complicated filtering.

The generic idea for addressing the aforementioned issues is to apply a non-sinusoidal magnetic excitation field and to calculate the responses of the individual beads from the observed signal. This is based on the recognition that the dynamic magnetic properties of the beads, e.g. the re-magnetization time and the Neel relaxation time, differ due to (i) process tolerances and (ii) deliberately applied differences for multiplexing purposes.

In a first particular embodiment of the above general concept, the excitation wires 11, 13 generate a square-wave excitation field B. Due to the different dynamic properties of the beads 2, 2′, a complex read-out signal is obtained, which may be analyzed in the frequency domain.

FIG. 2 shows the corresponding square-wave excitation current I₁ of the periodic excitation frequency f₁ and its associated Fourier frequency spectrum I₁* which comprises harmonics at the odd multiples of the excitation frequency f₁.

FIG. 3 shows schematically three different frequency response curves for three groups of magnetic beads 2, 2′, 2″ having different dynamic magnetic properties. If a mixture of these beads 2, 2′, 2″ is exposed to a square-wave excitation field according to FIG. 2, a complex frequency spectrum is generated which is the sum of the individual particle responses. This total readout signal obtained from the GMR sensor 12 is shown in FIG. 4. The individual contributions of the different beads are indicated by separate arrows. Furthermore, the frequency response curves of FIG. 3 are inserted into FIG. 4, placed one upon the other in dashed lines.

In the shown particular example, the contribution of each group of beads 2, 2′, 2″ may be obtained by first measuring the responses from beads 2″, which generate the most high-frequency signal content. Starting at 5f₁, where the read-out signal is only affected by beads 2″, the contribution of beads 2″ can be calculated and subtracted from the residual read-out signal. Then the responses of beads 2′ can be calculated etc. At the end, all individual bead responses are obtained. The basic frequency f₁ may be varied to achieve optimal excitation (SNR) of each bead type, e.g. by choosing f₁ higher to generate more HF signal for excitation of the smaller beads.

An alternative approach to separate the contributions of different beads may be based on a time domain analysis. In this case, individual bead responses are calculated in the time-domain by fitting the total response as function of time by exponential functions with different decay times. Standard algorithms like a least square fit are available in literature to fit the linear coefficients cᵢ and the decay times dᵢ in a linear combination of these so-called hyper-exponential functions of the kind

$$F ( t ) = {\sum }_{i} {c}_{i} {f}_{i} ( t ) = {\sum }_{i} {c}_{i} exp ( - t / {d}_{i} ) \qquad ( 1 )$$

(cf. e.g. H. B. Nielsen, Separable NonLinear Least Squares. Report IMM-REP-2000-01, Department of Mathematical Modelling, DTU. (2000), http://www2.imm.dtu.dk/˜hbn/publ/).

Consider for example data points (t₁, y₁), . . . (tₘ, yₘ) of a total signal y(t) as being given, wherein said signal shall be reconstructed by the linear combination F(t) of a number of non-linear functions fᵢ(t)=exp(−t/dᵢ) according to equation (1). It is then an objective of the algorithm to find the parameters cᵢ and dᵢ in such a way that the error E between the signal y(t) and the approximation F(t) is minimal on the data points according to some criterion. If for example the mean square error criterion is considered, the error E would be calculated as follows:

$$E = {[ {\sum }_{k = 1}^{m} {( {y}_{k} - F ( {t}_{k} ) )}^{2} ]}^{1 / 2} = {[ {\sum }_{k = 1}^{m} {( {y}_{k} - {\sum }_{i} {c}_{i} exp ( - {t}_{k} / {d}_{i} ) )}^{2} ]}^{1 / 2} \qquad ( 2 )$$

Several known mathematical algorithms can be applied to solve this optimization problem. An example is the Marquardt iteration or Levenberg-Marquardt method. Any other mathematical method to fit hyper-exponential functions with a set of exponential functions with different decay times is however possible as well.

In the FIGS. 5 to 9, different preferred front-end architectures for the processing circuitry of a magnetic sensor device like that of FIG. 1 are shown. All these architectures use ring modulators (choppers) for signal generation and demodulation. Said ring modulators (abbreviated RM) are well known from the field of signal conversion (ADC and DAC) and telecommunication. The intention is to demodulate the sensor signal of the GMR sensor 12 directly without amplification to avoid dynamic range problems, wherein the success of this concept depends on the quality of the ring modulators in terms of noise, offset and spurious components.

In a first particular architecture shown in FIG. 5, the excitation current I₁ through the excitation wires 11, 13 is generated by the output of an “excitation RM” 22, said RM being coupled to a DC current source 21 at its input side and to an oscillator 41 of frequency f₁ at its control input, wherein the RM 22, the current source 21, and the oscillator 41 constitute the corresponding excitation power supply unit. Similarly, the sensing current 12 through the GMR sensor 12 is generated by chopping a DC current source 23 with a “sensing RM” 24 at frequency f₂, said frequency being generated by a sensing oscillator 42, wherein the RM 24, the current source 23, and the oscillator 42 constitute the corresponding sensor power supply unit. The frequency spectrum of the original GMR voltage UGMR is depicted in graph A below the circuitry. It consist of lines at the frequencies m·f₂, k·f₁ and k·f₁±m·f₂ with m, k being integer and odd. The components m·f₂ of this spectrum are generated by the square wave sensor current I₂ as result of the static GMR resistance times the sensor current. The components k·f₁ (excitation current at frequency f₁ and its odd harmonics) are present at this point due to parasitic crosstalk (capacitive and inductive). The magnetic signal appears as sidebands of said signal, i.e. at k·f₁±m·f₂. Short arrows with dot indicate the demodulation frequency components. The GMR voltage UGMR is further processed in an “evaluation unit” comprising the components that are shown to the right of the GMR sensor 12 and that will be described in the following in more detail.

The GMR voltage UGMR is a first time demodulated by a first demodulation RM 26, which is controlled by the oscillator 41 (or another oscillator of frequency f₁). The output of this RM 26 is shown in the frequency spectrum of graph B. Due to the first demodulation step, the lines around k·f₁ have been shifted to DC. DC compares to f₁ and the harmonics at k·f₂ to the magnetic signal.

The output of RM 26 is then sent though a low-pass filter 27 and a low noise amplifier 28, and finally demodulated by a second demodulation RM 29, which is controlled by the oscillator 42 (or another oscillator of frequency f₂). The final output of the second RM 29 is shown in graph C. By applying the second demodulation step at f₂, the harmonics at k·f₂ of graph B have been shifted to DC. At the same moment the DC term of graph B has been shifted to k·f₂.

After the successive demodulation steps at f₁ and f₂, the desired magnetic signal thus appears at DC (graph C) and can therefore be obtained by low pass filtering the DC term. Optionally a low noise amplifier 25 (indicated in dashed lines) can be added prior to the first demodulation RM 26.

In an alternative embodiment, the second demodulation step is preceded by a high-pass filter 30 (cf. upper insertion in FIG. 5) which removes the DC component from graph B to avoid low-pass filtering after the second demodulation. The resulting output signal for this case is shown in graph C′.

In a second type of architecture shown in FIG. 6, a high-pass filter (e.g. a capacitor 31 to form a first order high pass filter with the input resistance of the LNA) is added before the residual processing circuitry for the sensor signal UGMR. Thus the dynamic range of the front-end is limited, which enables amplification prior to demodulation. The low-pass filter 27 of FIG. 5 can be omitted in this case. The other components are however the same as in FIG. 5 and will therefore not be described again. The frequency spectrum of the processed GMR signal UGMR at various points A, B, and C is shown in the graphs below the circuitry. An additional low pass filter (dashed line in graph B) can be used to remove HF components before the second demodulation step.

As a variation, a high-pass filter 30 at f₂ can again be inserted before the second demodulation RM 29, said filter 30 removing DC components after the first demodulation. If this high-pass filter is combined with the aforementioned additional low pass filter, this results in a band-pass filter which passes f₂ and harmonics.

A third type of architecture shown in FIG. 7 comprises a direct-conversion to DC by generating the required demodulation frequencies at the first demodulation RM 26 by the exclusive-or (XOR) of f₁ and f₂ in an oscillator 43. The other components are—if present—the same as in FIGS. 5 and 6 and will therefore not be described again. The frequency spectrum of the processed GMR signal UGMR at points A and C is shown in the graphs below the circuitry.

In a fourth type of architecture shown in FIG. 8, the large base band component at the sensing frequency f₂ is removed prior to amplification by chopping the GMR voltage UGMR at frequency f₂ with a (third) RM 32. This has the strong advantage that the base band is mixed to DC, which may be removed completely by DC blocking means (e.g. a capacitor 31) or used as bias. The other components are—if present—the same as in FIGS. 5, 6 and 7 and will therefore not be described again. The frequency spectrum of the processed GMR signal UGMR at points A to D is shown in the graphs below the circuitry.

Although being orthogonal to the magnetic desired signal, it is desirable to avoid harmonic content from the sensing current frequency f₂ at the magnetic signal. Hence the following relation should hold:

p·f₂≠q·f₁±r·f₂

with p, q and r being integer and odd.

Preferably f₁ and f₂ are derived from the same reference clock, so that f₁=f_{ref}/n and f₂=f_{ref}/m. This reduces the above constraint to

$$\frac{p}{m} \neq \frac{q}{n} \pm \frac{r}{m} p \neq q \cdot \frac{m}{n} \pm r$$

with p, q and r being integer and odd, which can easily be met by choosing 2m/n an integer value. In the case of m=10.050, n=100, and f_{ref}=10 MHz, frequencies f₁=100 kHz and f₂=995 Hz are generated.

In a fifth type of architecture shown in FIG. 9, the excitation frequency f₁ and the sensing frequency f₂ are close together. The low-frequency difference frequency Δf=|f₂−f₁| is amplified and synchronously detected, wherein a first low-pass filter 34 immediately after the GMR sensor 12 serves to limit the dynamic range of the following LNA amplifier 25. Furthermore, a second low-pass filter 35 after the amplifier 25 removes HF noise of the amplifier. The other components are—if present—the same as in FIGS. 5 to 8 and will therefore not be described again. The frequency spectrum of the processed GMR signal UGMR at points A to C is shown in the graphs below the circuitry.

In the described architectures, the required control signals f₁, f₂ and (f₁ xor f₂) are preferably generated digitally. Moreover, the use of non-square wave signals for one of the currents I₁ and/or I₂ is part of the invention. In that case the demodulation spectra must be adapted accordingly to achieve the optimal SNR. Furthermore, adding slew-rate limitation to the waveforms will change the HF content of the signals, which may ease the implementation.

Advantages of the described magnetic sensor devices are:
possibility of bead multiplexing on a single GMR sensor by discriminating between the frequency and time response of said beads;
facilitating system integration: no complicated filtering necessary, only two frequencies to be generated etc.;
fully transparent and synchronous system; operating frequencies can be changed without changing cut-off frequencies of filters etc.;
optimal SNR by demodulating all signal-containing frequency components.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A magnetic sensor device (10) for the detection of magnetized particles (2, 2′, 2″), comprising:
at least one magnetic field generator (11, 13) for generating a magnetic excitation field (B);
at least one associated magnetic sensor element (12) for recording the magnetic reaction fields (B′) generated by the particles (2, 2′, 2″) in reaction to the excitation field (B);
an excitation power supply unit for providing the magnetic field generator (11, 13) with an excitation current (I₁) that comprises at least two spectral components.

2. The magnetic sensor device (10) according to claim 1,
characterized in that it comprises an evaluation unit for extracting the individual contributions of particles (2, 2′, 2″) of different properties from the recorded magnetic reaction fields (B′).

3. The magnetic sensor device (10) according to claim 1,
characterized in that the excitation power supply unit comprises at least two oscillators, preferably sine oscillators.

4. The magnetic sensor device (10) according to claim 1,
characterized in that the excitation power supply unit generates a square-wave excitation current of an excitation frequency f₁.

5. The magnetic sensor device (10) according to claim 1,
characterized in that the excitation power supply unit comprises an excitation RM (ring modulator) (22), an excitation current source (21), and an excitation oscillator (41) for providing an excitation current (I₁) of an excitation frequency (f₁) at the output of the RM, said RM being controlled by the oscillator (41) and coupled at its input to the current source (21).

6. The magnetic sensor device (10) according to claim 5,
characterized in that the excitation current source (21) provides a direct current and the excitation oscillator (41) provides a square-wave of an excitation frequency fl.

7. The magnetic sensor device (10) according to claim 1,
characterized in that it comprises a sensor power supply unit for providing the magnetic sensor element (12) with a square-wave sensing current (I₂) of a sensing frequency f₂.

8. The magnetic sensor device (10) according to claim 1, characterized in that it comprises a sensor power supply unit with a sensing RM (ring modulator) (24), a sensing current source (23), and a sensing oscillator (42) for providing the magnetic sensor element (12) with a sensing current (I₂) of a sensing frequency (f₂) from the output of the RM, said RM being controlled by the oscillator (42) and coupled at its input to the current source (23).

9. The magnetic sensor device (10) according to claim 8, characterized in that the sensing current source (23) provides a direct current and the sensing oscillator (42) provides a square-wave of the sensing frequency f₂.

10. The magnetic sensor device (10) according to claim 4,
characterized in that the excitation frequency f₁ and that sensing frequency f₂ fulfill the relation p·f₂≠q·f₁±r·f₂, for any p, q, and r being integer and odd.

11. The magnetic sensor device (10) according to claim 4,
characterized in that the ratio between the excitation frequency f₁ and the sensing frequency f₂ fulfills at least one of the following relations: f₁:f₂ε[0.8; 1.2], f₁:f₂>1, or f₁:f₂ε[10; 1000].

12. The magnetic sensor device (10) according to claim 5,
characterized in that the excitation oscillator (41) and the sensing oscillator (42) are driven by a common reference oscillator.

13. The magnetic sensor device (10) according to claim 1,
characterized in that the magnetic sensor element comprises a magneto-resistive element like a GMR (12), a TMR, or an AMR element.

14. The magnetic sensor device (10) according to claim 4,
characterized in that it comprises at least one demodulator (26, 29) that is coupled to the magnetic sensor element (12) and that is driven by the excitation frequency f₁, the sensing frequency f₂, or the result of an exclusive-or operation between the excitation frequency f₁ and the sensing frequency f₂.

15. The magnetic sensor device (10) according to claim 5,
characterized in that it comprises a first demodulation RM (26) that is controlled by a first control signal derived from the excitation oscillator (41) and that is coupled at its input to the output of the magnetic sensor element (12).

16. The magnetic sensor device (10) according to claim 15, characterized in that the first control signal is determined by the output of the excitation oscillator (41) or by an exclusive-or operation between the outputs of the excitation oscillator (41) and another oscillator.

17. The magnetic sensor device (10) according to claim 15,
characterized in that it comprises a high-pass filter (31) or a low-pass filter (27) at the input side and/or at the output side of the first demodulation RM (26).

18. The magnetic sensor device (10) according to claim 15,
characterized in that it comprises an amplifier (25) at the input side and/or an amplifier (28) at the output side of the first demodulation RM (26).

19. The magnetic sensor device (10) according to claim 8,
characterized in that it comprises a second demodulation RM (29) that is controlled by a second control signal derived from the sensing oscillator (42) and that is coupled at its input side to the output of the first demodulation RM (26).

20. The magnetic sensor device (10) according to claim 19,
characterized in that it comprises a high-pass filter (30) at the input side and/or a low-pass filter at the output side of the second demodulation RM (29).

21. The magnetic sensor device (10) according to claim 8,
characterized in that it comprises a third RM (32) between the magnetic sensor element (12) and the first demodulation RM (26), said third RM (32) being controlled by the sensing oscillator (42).

22. (canceled)

23. (canceled)

24. (canceled)

25. (canceled)

26. (canceled)

27. (canceled)
